(19) United States
(12) Patent Application Publication
(10) Pub. No.: US 2010/0118056 A1
(43) Pub. Date: May 13, 2010

(54) PLASMA DISPLAY DEVICE AND PLASMA DISPLAY PANEL DRIVING METHOD

(76) Inventors: Takahiko Origuchi, Osaka (JP); Hidehiko Shoji, Osaka (JP); Mitsuo Ueda, Hyogo (JP); Toshiyuki Maeda, Hyogo (JP)

Correspondence Address: WENDEROTH, LIND & PONACK L.L.P., 1030 15th Street, N.W., Suite 400 East, Washington, DC, 20005-1503, US

(21) Appl. No.: 11/995,021

(22) PCT Filed: Jul. 6, 2007
(86) PCT No.: PCT/JP2007/063557

§ 371 Date: Jan. 8, 2008

(30) Foreign Application Priority Data
Jul. 11, 2006 (JP) 2006-189983
Aug. 10, 2006 (JP) 2006-218047

(51) Int. Cl. G09G 5/10

(52) U.S. Cl. 345/690; 345/63

(57) ABSTRACT

In a plasma display device and a method for driving a plasma display panel, fluctuation of emission luminance of a discharge cell is reduced and display quality of an image is improved. The plasma display device is provided with a plasma display panel having a plurality of scanning electrodes and sustaining electrodes which configure a display electrode pair. The plasma display device is also provided with a sustaining pulse generating circuit, which has a plurality of subfields having an initializing period, a writing period and a sustaining period in one field period, and generates three kinds of sustaining pulses, i.e., a first sustaining pulse to be reference, a second sustaining pulse whose start-up is sharper than that of the first sustaining pulse and that of a third sustaining pulse, and the third sustaining pulse whose trailing edge is sharper than that of the first sustaining pulse and that of the second sustaining pulse, by periodically switching the pulses. In a sustaining period of at least one subfield in one field period, the third sustaining pulse is applied to one electrode of the electrode pair, then just after the application, the second sustaining pulse is applied to the other electrode of the display electrode pair.

### TECHNICAL FIELD

The present invention relates to a plasma display device and a plasma display panel driving method for use in a wall-mounted television or a large monitor.

### BACKGROUND ART

An alternating-current surface-discharging panel representative of a plasma display panel (hereinafter abbreviated as “panel”) has a large number of discharge cells formed between the front plate and the rear plate faced to each other. For the front plate, a plurality of display electrode pairs, each made of a scan electrode and a sustain electrode, are formed on a front glass substrate in parallel with each other. A dielectric layer and a protective layer are formed to cover these display electrode pairs. For the rear plate, a plurality of parallel data electrodes are formed on a rear glass substrate and a dielectric layer is formed over the data electrodes to cover them. Further, a plurality of barrier ribs are formed on the dielectric layer in parallel with the data electrodes. Phosphor layers are formed over the surface of the dielectric layer and the side faces of the barrier ribs. Then, the front plate and the rear plate are faced to each other and sealed together so that the display electrode pairs are intersected with data electrodes. A discharge gas containing xenon in a partial pressure ratio of 5%, for example, is charged into the inside discharge space formed between the plates. Discharge cells are formed in portions where the respective display electrode pairs are faced to the corresponding data electrodes. For a panel structured as above, gas discharge generates ultraviolet light in each discharge cell. This ultraviolet light excites the red (R), green (G), and blue (G) phosphors so that they emit the respective colors for color display.

A general method of driving a panel is a sub-field method; one field period is divided into a plurality of sub-fields and combinations of light-emitting sub-fields provide gradation display.

Each sub-field has a setup period, an address period, and a sustain period. In the setup period, initializing discharge is caused to form wall charge necessary for the succeeding addressing operation on the respective electrodes. The initializing operations include an initializing operation for causing initializing discharge in all the discharge cells (herein after abbreviated as “all-cell initializing operation”), and an initializing operation for causing initializing discharge in the discharge cells having generated sustaining discharge (hereinafter “selective initializing operation”).

In the address period, application of address pulse voltage selectively to the discharge cells to be lit causes addressing discharge and forms wall charge (hereinafter this operation also referred to as “addressing”). In the sustain period, alternately applying sustain pulses to the display electrode pairs, each made of a scan electrode and a sustain electrode, causes sustaining discharge in the discharge cells having generated addressing discharge, and causes the phosphor layers of the corresponding discharge cells to emit light. Thus, an image is displayed.

In this sub-field method, the light emission unrelated to gradation display can be minimized to improve the contrast ratio by performing the all-cell initializing operation for discharging all the discharge cells in the setup period of one of the plurality of sub-fields, and causing initializing discharge selectively in the discharge cells having generated sustaining discharge, in the setup periods of the other sub-fields.

Generally used as a circuit for applying sustain pulses to display electrode pairs is a so-called power recovery circuit capable of reducing power consumption (see Patent Document 1, for example). Patent Document 1 discloses a power recovery circuit based on the idea that each of display electrode pairs is a capacitive load having interelectrode capacitance of the display electrode pair. In the power recovery circuit, a resonance circuit including an inductor as a component is used to cause LC resonance between the inductor and interelectrode capacitance, recover the electric charge stored in the interelectrode capacitance, and reuse the recovered electric charge for driving the display electrode pairs.

On the other hand, with recent increases in the screen size and definition of panels, various efforts are made to improve emission efficiency and luminance of the panels. For example, discussions are made on substantial improvement of the emission efficiency by increasing the xenon partial pressure. However, a higher xenon partial pressure causes greater variations in the discharge generation timing. This can cause variations in the emission intensity between discharge cells and thus nonuniform display luminance. Disclosed to address this nonuniformity of the luminance is a driving method in which insertion of a sustain pulse having a steep rise once out of a plurality of times, for example, synchronizes the sustaining discharge timings and thus makes the display luminance uniform (Patent Document 2).

However, shortening the rise time of a sustain pulse to make a steep rise causes stronger sustaining discharge in comparison with the case where the rise is not steep.

Generation of strong discharge increases the discharge current, thus increasing the voltage drop caused by the impedance along the path of the discharge current. The light-emitting rate of the respective display electrode pairs varies with the display image. The amount of voltage drop also varies with the display electrode pair, thus causing differences in the voltage applied to the respective discharge cells. Further, changes in the amount of current causes not only the voltage drop but also waveform changes in the rise of the scan pulse voltage probably resulting from the interelectrode capacitance or the like. Because the waveform changes in the rise have an influence on the generation of discharge, this influence may cause differences in emission intensity between a portion having low light-emitting rates and a portion having high light-emitting rates. Thus, shortening the rise time of a sustain pulse and providing a steep rise to synchronize the sustaining discharge timings generates differences in the emission intensity resulting from a cause other than the different sustaining discharge timings.

### [Patent Document 1] Japanese Translation of PCT Publication H07-109542

### [Patent Document 2] Japanese Patent Unexamined Publication 2005-338120

### SUMMARY OF THE INVENTION

A plasma display device includes the following elements: a panel including a plurality of scan electrodes and sustain electrodes for constituting display electrode pairs; and a sustain pulse generating circuit for generating, in a sustain period, sustain pulses having variable slopes of the rise or fall. One field period has a plurality of sub-fields, each including a setup period, an address period, and a sustain period. In the sustain period of at least one sub-field in one field period, the sustain pulse generating circuit generates and switches at least two kinds of the sustain pulses: one sustain pulse having a steeper fall than another sustain pulse; and the other sustain pulse having a steeper rise than another sustain pulse. Immediately after applying the sustain pulse having the steeper fall to one electrode of each electrode pair, the sustain pulse generating circuit applies the sustain pulse having the steeper rise to the other electrode of each electrode pair.

This structure can reduce variations in the emission luminance between the discharge cells, and improve the quality of displaying images.

### BRIEF DESCRIPTION OF THE DRAWINGS

FIG. 1 is an exploded perspective view illustrating a structure of a panel in accordance with a first exemplary embodiment of the present invention.

FIG. 2 is a diagram illustrating an array of electrodes of the panel.

FIG. 3 is a schematic diagram of driving waveforms showing a sub-field structure in accordance with the first exemplary embodiment.

FIG. 4 is a diagram of driving voltage waveforms to be applied to the respective electrodes of the panel in accordance with the first exemplary embodiment.

FIG. 5 is a diagram schematically showing waveforms of a first sustain pulse, a second sustain pulse, and a third sustain pulse in accordance with the first exemplary embodiment.

FIG. 6A is a schematic diagram showing a generation order of the first sustain pulses, the second sustain pulses, and the third sustain pulses in a sustain period in accordance with the first exemplary embodiment.

FIG. 6B is a schematic diagram showing the generation order of the first sustain pulses, the second sustain pulses, and the third sustain pulses in the sustain period in accordance with the first exemplary embodiment.

FIG. 7A is a diagram of a waveform schematically showing a result of an experiment on sustaining discharge intensity in accordance with the first exemplary embodiment.

FIG. 7B is a diagram of a waveform schematically showing the result of the experiment on the sustaining discharge intensity in accordance with the first exemplary embodiment.

FIG. 7C is a diagram of a waveform schematically showing the result of the experiment on the sustaining discharge intensity in accordance with the first exemplary embodiment.

FIG. 8 is a circuit block diagram of a plasma display device in accordance with the first exemplary embodiment of the present invention.

FIG. 9 is a circuit diagram of sustain pulse generating circuits in accordance with the first exemplary embodiment.

FIG. 10 is a diagram showing a waveform of the first sustain pulse in accordance with the first exemplary embodiment.

FIG. 11 is a diagram showing a waveform of the second sustain pulse in accordance with the first exemplary embodiment.

FIG. 12 is a diagram showing a waveform of the third sustain pulse in accordance with the first exemplary embodiment.

FIG. 13A is a schematic diagram showing a generation order of first sustain pulses, second sustain pulses, and third sustain pulses in a sustain period in accordance with a second exemplary embodiment.

FIG. 13B is a schematic diagram showing the generation order of the first sustain pulses, the second sustain pulses, and the third sustain pulses in the sustain period in accordance with the second exemplary embodiment.

FIG. 14 is a schematic diagram showing an example of a generation order of sustain pulses in accordance with a third exemplary embodiment of the present invention.

FIG. 15 is a schematic diagram showing another example of the generation order of sustain pulses in accordance with the third exemplary embodiment.

FIG. 16 is a schematic diagram showing still another example of the generation order of sustain pulses in accordance with the third exemplary embodiment.

FIG. 17 is a schematic diagram showing yet another example of the generation order of sustain pulses in accordance with the third exemplary embodiment.

### REFERENCE MARKS IN THE DRAWINGS

1 Plasma display device
10 Panel
21 Front plate
22 Scan electrode
23 Sustain electrode
24, 33 Dielectric layer
25 Protective layer
28 Display electrode pair
31 Rear plate
32 Data electrode
34 Barrier rib
35 Phosphor layer
51 Image signal processing circuit
52 Data electrode driver circuit
53 Scan electrode driver circuit
54 Sustain electrode driver circuit
55 Timing generating circuit
100, 200 Sustain pulse generating circuit
110, 210 Power recovery circuit
120, 220 Clamp circuit
Q11, Q12, Q13, Q14, Q21, Q22, Q23, Q24, Q26, Q27, Q28, Q29 Switching element
D11, D12, D21, D22, D20 Diode
C10, C20 Capacitor
L10, L20 Inductor
Cp Interelectrode capacitance
VE1, ΔVE, VS Power supply

### DETAILED DESCRIPTION OF PREFERRED EMBODIMENTS

Hereinafter, a description is provided of a plasma display device in accordance with exemplary embodiments of the present invention, with reference to the accompanying drawings.

### First Exemplary Embodiment

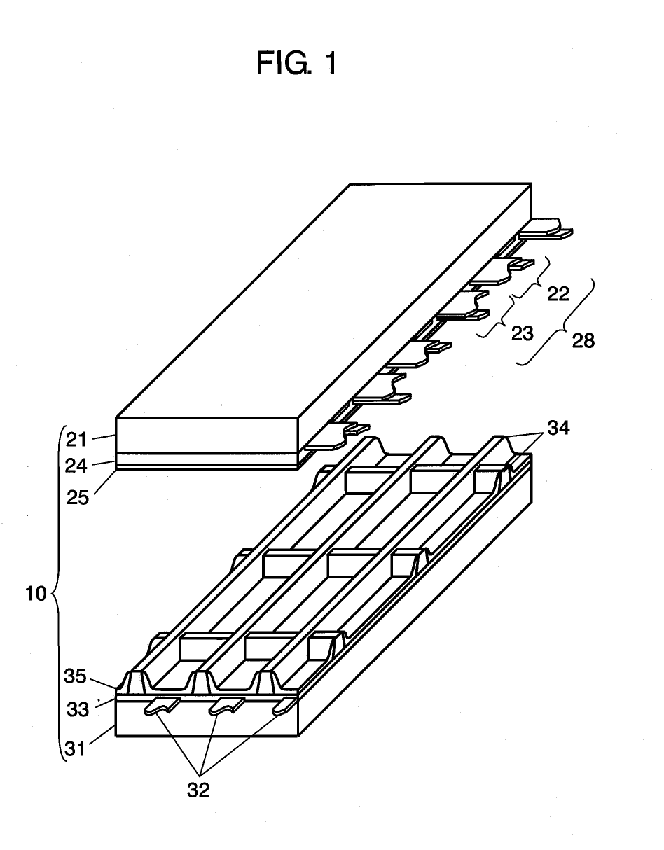

FIG. 1 is an exploded perspective view illustrating a structure of panel 10 in accordance with the first exemplary embodiment of the present invention. A plurality of display electrode pairs 28, each made of scan electrode 22 and sustain electrode 23, are formed on glass front plate 21. Dielectric layer 24 is formed to cover scan electrodes 22 and sustain electrodes 23. Protective layer 25 is formed over dielectric layer 24. A plurality of data electrodes 32 are formed on rear plate 31. Dielectric layer 33 is formed to cover data electrodes 32. On the dielectric layer, barrier ribs 34 are formed in a double cross. Further, over the side faces of barrier ribs 34 and dielectric layer 33, phosphor layers 35 for emitting red (R), green (G), or blue (B) light are provided.

These front plate 21 and rear plate 31 are faced to each other sandwiching a small discharge space therebetween so that display electrode pairs 28 are intersected with data electrodes 32. The outer peripheries of the plates are sealed with a sealing material, such as a glass frit. In the discharge space, a mixed gas of neon and xenon, for example, is charged as a discharge gas. In this exemplary embodiment, a discharge gas having a xenon partial pressure of approximately 10% is used to improve the luminance. The discharge space is partitioned into a plurality of compartments by barrier ribs 34. Discharge cells are formed at intersections between display electrode pairs 28 and data electrodes 32. Discharging and lighting in these discharge cells allows image display.

The structure of the panel is not limited to the above, and may include stripe-like barrier ribs. The mixing ratio of the discharge gas is not limited to the above, and the other mixing ratios can be used.

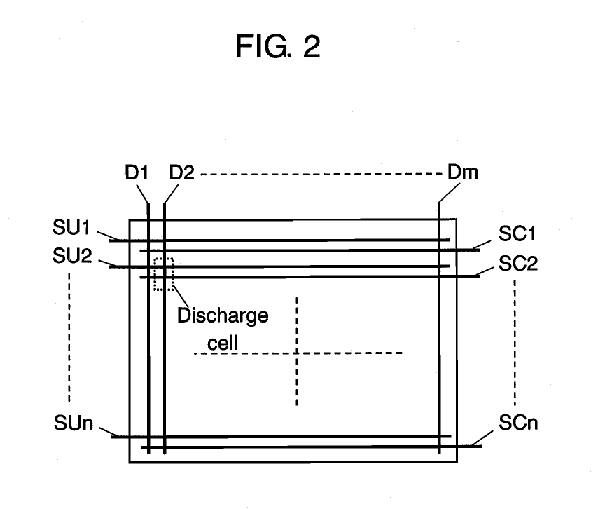

FIG. 2 is a diagram showing an array of electrodes of panel 10 in accordance with the first exemplary embodiment of the present invention. Panel 10 includes n scan electrodes SC1 to SCn (scan electrodes 22 in FIG. 1) and n sustain electrodes SU1 to SUn (sustain electrodes 23 in FIG. 1) both long in the row direction, and m data electrodes D1 to Dm (data electrodes 32 in FIG. 1) long in the column direction. A discharge cell is formed in a portion where a pair of scan electrode SCi (i=1 to n) and sustain electrode SUi are intersected with one data electrode Dj (j=1 to m). Thus, m×n discharge cells are formed in the discharge space.

Next, a description is provided of driving voltage waveforms for driving panel 10 and the operation thereof. A plasma display device of the present invention provides gradation display by the sub-field method; one field period is divided into a plurality of sub-fields and whether to light the respective discharge cells or not is controlled for each of the sub-fields. Each sub-field has a setup period, an address period, and a sustain period.

In the setup period, initializing discharge is caused to form wall charge necessary for the succeeding addressing discharge, on the respective electrodes. The initializing operations performed at this time include an all-cell initializing operation for causing initializing discharge in all the discharge cells, and a selective initializing operation for causing initializing discharge in the discharge cells having generated sustaining discharge in the preceding sub-field.

In the address period, addressing discharge is generated to form wall charge selectively in the discharge cells to be lit in the succeeding sustain period. In the sustain period, alternate application of the number of sustain pulses proportional to the brightness weight to display electrode pairs 28 causes sustaining discharge for light emission in the discharge cells having generated addressing discharge. This proportionality factor is called “luminance factor”.

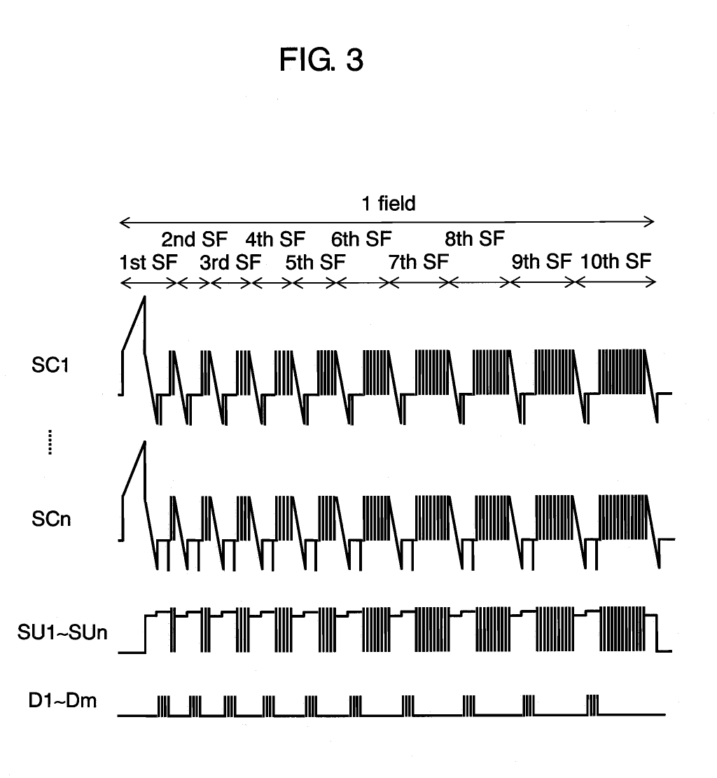

FIG. 3 is a schematic diagram of driving waveforms showing a sub-field structure in accordance with the first exemplary embodiment. FIG. 3 schematically shows the driving voltage waveforms in one field in the sub-field method. The driving voltage waveforms in each sub-field (SF) are described later.

FIG. 3 shows a sub-field structure in which one field is divided into 10 SFs (the first SF, and second SF to tenth SF), and the respective sub-fields have different brightness weights (e.g. 1, 2, 3, 6, 11, 18, 30, 44, 60, and 80). In this sub-field structure, the all-cell initializing operation is performed in the setup period of the first SF (hereinafter a SF for performing the all-cell initializing operation being abbreviated as “all-cell initializing sub-field”), and the selective initializing operation is performed in the setup periods of the second through 10th SFs (hereinafter a SF for performing the selective initializing operation being abbreviated as “selective initializing sub-field”).

In the sustain period of each sub-field, the number of sustain pulses resulting from multiplying the brightness weight of the sub-field by a predetermined luminance factor is applied to each of display electrode pairs 28. However, in this exemplary embodiment, the number of sub-fields and the luminance factor of each sub-field are not limited to the above values. The sub-field structure can be switched according to image signals or the like.

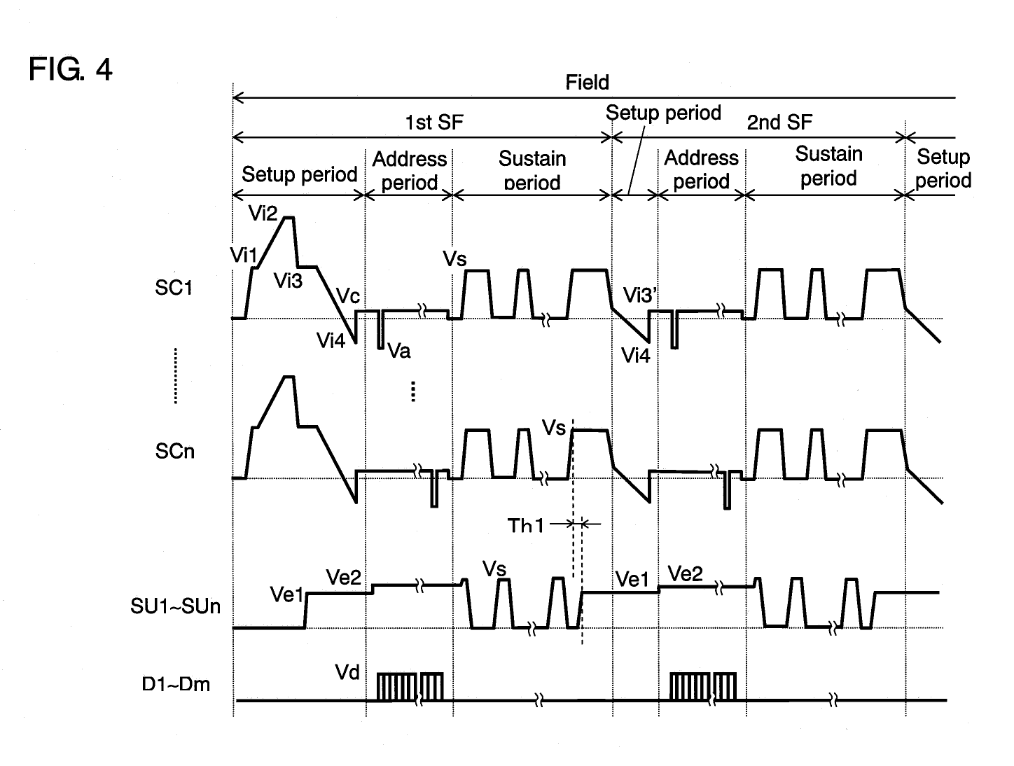

FIG. 4 is a diagram showing driving voltage waveforms to be applied to the respective electrodes of panel 10 of the first exemplary embodiment of the present invention. FIG. 4 shows driving voltage waveforms in two sub-fields, i.e. an all-cell initializing sub-field and a selective initializing sub-field. The driving voltage waveforms in the other sub-fields are similar to these waveforms.

First, a description is provided of the first SF, i.e. an all-cell initializing sub-field.

In the first half of the setup period in the first SF, a voltage of 0 (V) is applied to respective data electrodes D1 to Dm and sustain electrodes SU1 to SUn. Applied to scan electrodes SC1 to SCn is a ramp waveform voltage that gradually increases from voltage Vi1 of a breakdown voltage or lower to voltage Vi2 exceeding the breakdown voltage with respect to sustain electrodes SU1 to SUn.

While this ramp waveform voltage is increasing, weak initializing discharge occurs between scan electrodes SC1 to SCn and sustain electrodes SU1 to SUn, and between scan electrodes SC1 to SCn and data electrodes D1 to Dm. Then, negative wall voltage accumulates on scan electrodes SC1 to SCn. Positive wall voltage accumulates on data electrodes D1 to Dm and sustain electrodes SU1 to SUn. Now, the wall voltage on the electrodes means the voltage generated by the wall charge accumulated on the dielectric layer, protective layer, phosphor layers, and the like covering the electrodes.

In the second half of the setup period, a positive voltage of Ve1 is applied to sustain electrodes SU1 to SUn. Applied to scan electrodes SC1 to SCn is a ramp waveform voltage that gradually decreases from voltage Vi3 of the breakdown voltage or lower to voltage Vi4 exceeding the breakdown voltage with respect to sustain electrodes SU1 to SUn. During this application, weak initializing discharge occurs between scan electrodes SC1 to SCn and sustain electrodes SU1 to SUn, and between scan electrodes SC1 to SCn and data electrodes D1 to Dm. This weak discharge weakens the negative wall voltage on scan electrodes SC1 to SCn and the positive wall voltage on sustain electrodes SU1 to SUn, and adjusts the positive wall voltage on data electrodes D1 to Dm to a value appropriate for the addressing operation. Thus, the all-cell initializing operation for causing initializing discharge in all the discharge cells is completed.

In the succeeding address period, voltage Ve2 is applied to sustain electrodes SU1 to SUn, and voltage Vc is applied to scan electrodes SC1 to SCn.

First, negative scan pulse voltage Va is applied to scan electrode SC1 in the first row, and positive address pulse voltage Vd is applied to data electrode Dk (k=1 to m) of the discharge cell to be lit in the first row. At this time, the voltage difference at the intersection between data electrode Dk and scan electrode SC1 is the addition of the difference in externally applied voltage (Vd−Va), and the difference between the wall voltage on data electrode Dk and the wall voltage on scan electrode SC1, thus exceeding the breakdown voltage. Then, addressing discharge occurs between data electrodes Dk and scan electrode SC1, and between sustain electrode SU1 and scan electrode SC1. Positive wall voltage accumulates on scan electrode SC1 and negative wall voltage accumulates on sustain electrode SU1. Negative wall voltage also accumulates on data electrode Dk.

In this manner, the addressing operation is performed to cause addressing discharge in the discharge cells to be lit in the first row, and to accumulate wall voltage on the corresponding electrodes. On the other hand, the voltage at the intersections between data electrodes D1 to Dm subjected to no address pulse voltage Vd and scan electrode SC1 does not exceed the breakdown voltage, thus causing no addressing discharge. The above addressing operation is performed on the discharge cells up to the n-th row and the address period is completed.

In the succeeding sustain period, first, positive sustain pulse voltage Vs is applied to scan electrodes SC1 to SCn, and 0 (V) is applied to sustain electrodes SU1 to SUn. Then, in the discharge cells having generated addressing discharge in the preceding address period, the voltage difference between scan electrode SCi and sustain electrode SUi is the addition of sustain pulse voltage Vs and the difference between the wall voltage on scan electrode SCi and the wall voltage on sustain electrode SUi, thus exceeding the breakdown voltage.

Thus, sustaining discharge occurs between scan electrode SCi and sustain electrode SUi, and ultraviolet light generated at this time causes phosphor layers 35 to emit light. Then, negative wall voltage accumulates on scan electrode SCi, and positive wall voltage accumulates on sustain electrodes SUi. Positive wall voltage also accumulates on data electrode Dk. In the discharge cells having generated no addressing discharge in the address period, no sustaining discharge occurs and the wall voltage at the completion of the setup period is maintained.

Successively, 0 (V) is applied to scan electrodes SC1 to SCn, and sustain pulse voltage Vs is applied to sustain electrodes. SU1 to SUn. Then, in the discharge cell having generated sustaining discharge, the voltage difference between sustain electrode SUi and scan electrode SCi exceeds the breakdown voltage, thereby causing sustaining discharge between sustain electrode SUi and scan electrode SCi again. Thus, negative wall voltage accumulates on sustain electrode SUi, and positive wall voltage on scan electrode SCi. Similarly, the number of sustain pulses resulting from multiplying the brightness weight by the luminance factor is alternately applied to scan electrodes SC1 to SCn and sustain electrodes SU1 to SUn to give a potential difference between the electrodes of each display electrode pair. Thereby, sustaining discharge is continued in the discharge cells having generated addressing discharge in the address period.

At the end of the sustain period, applying voltage Ve1 to sustain electrodes SU1 to SUn specific period Th1 after the application of voltage Vs to scan electrodes SC1 to SCn gives a voltage difference of a so-called narrow pulse between scan electrodes SC1 to SCn and sustain electrodes SU1 to SUn. Thereby, while positive wall voltage remains on data electrode Dk, the entire wall voltage or a part thereof on scan electrode SCi and sustain electrode SUi is erased. Specifically, after sustain electrodes SU1 to SUn are returned to 0 (V) once, sustain pulse voltage Vs is applied to scan electrodes SC1 to SCn. Then, sustaining discharge occurs between sustain electrode SUi and scan electrode SCi of the discharge cell that have generated sustaining discharge. Before this discharge subsides, i.e. while the charged particles generated by the discharge sufficiently remain in the discharge space, voltage Ve1 is applied to sustain electrodes SU1 to SUn. This application decreases the voltage difference between sustain electrode SUi and scan electrode SCi to a degree of (Vs−Ve1). Then, the wall voltage on scan electrodes SC1 to SCn and sustain electrodes SU1 to SUn is alleviated to have voltage difference (Vs−Ve1), i.e. a difference between the voltages applied to the respective electrodes, while the positive wall charge on data electrode Dk remains. Hereinafter, this discharge is referred to as “erasing discharge”.

In this manner, after voltage Vs for generating the final sustaining discharge, i.e. the erasing discharge, is applied to scan electrodes SC1 to SCn, voltage Ve1 for alleviating the voltage difference between the electrodes of each display electrode pair is applied to sustain electrodes SU1 to SUn. Thus, the sustaining operation in the sustain period is completed.

Next, a description is provided of the operation in the second SF, i.e. a selective initializing sub-field.

In the selective setup period of the second SF, while voltage Ve1 is applied to sustain electrodes SU1 to SUn and 0 (V) is applied to data electrodes D1 to Dm, a ramp waveform voltage gradually decreasing from voltage Vi3′ to voltage Vi4 is applied to scan electrodes SC1 to SCn.

In the discharge cells having generated sustaining discharge in the sustain period of the preceding sub-field, weak initializing discharge occurs, and weakens the wall voltage on scan electrode SCi and sustain electrode SUi. On data electrode Dk, sufficient positive wall voltage is accumulated by the sustaining discharge generated immediately before, and thus the excessive wall voltage is discharged and adjusted to a value appropriate for the addressing operation.

On the other hand, in the discharge cells having generated no sustaining discharge in the preceding sub-field, no discharge occurs, and the wall charge at the completion of the setup period of the preceding sub-field is maintained.

In this manner, in the selective setup operation, the initializing discharge is performed selectively on the discharge cells subjected to the sustaining operation in the sustain period of the preceding sub-field.

The operation in the succeeding address period is the same as the operation in the address period of the all-cell initializing sub-field. Thus, the description is omitted. The operation in the succeeding sustain period is the same except for the number of sustain pulses.

In this exemplary embodiment, in a sustain period, three kinds of sustain pulses are generated and switched. The three kinds of sustain pulses include: a first sustain pulse, i.e. a reference pulse; a second sustain pulse having a steeper rise than the first sustain pulse and a third sustain pulse to be described later; and the third sustain pulse having a steeper fall than the first sustain pulse and the second sustain pulse. Further, the sustain pulses are generated and switched so that immediately after the third sustain pulse is applied to one electrode of each display electrode pair 28, the second sustain pulse is applied to the other electrode of each display electrode pair 28. This structure reduces variations in the emission luminance between the discharge cells. These operations are detailed later.

Next, a description is provided of a panel driving method of this exemplary embodiment. In the panel driving method of this exemplary embodiment, sustaining discharge is caused in a sustain period by using the following three kinds of sustain pulses: a first sustain pulse, i.e. a reference pulse; a second sustain pulse having a steeper rise than the first sustain pulse and a third sustain pulse; and the third sustain pulse having a steeper fall than the first sustain pulse and the second sustain pulse.

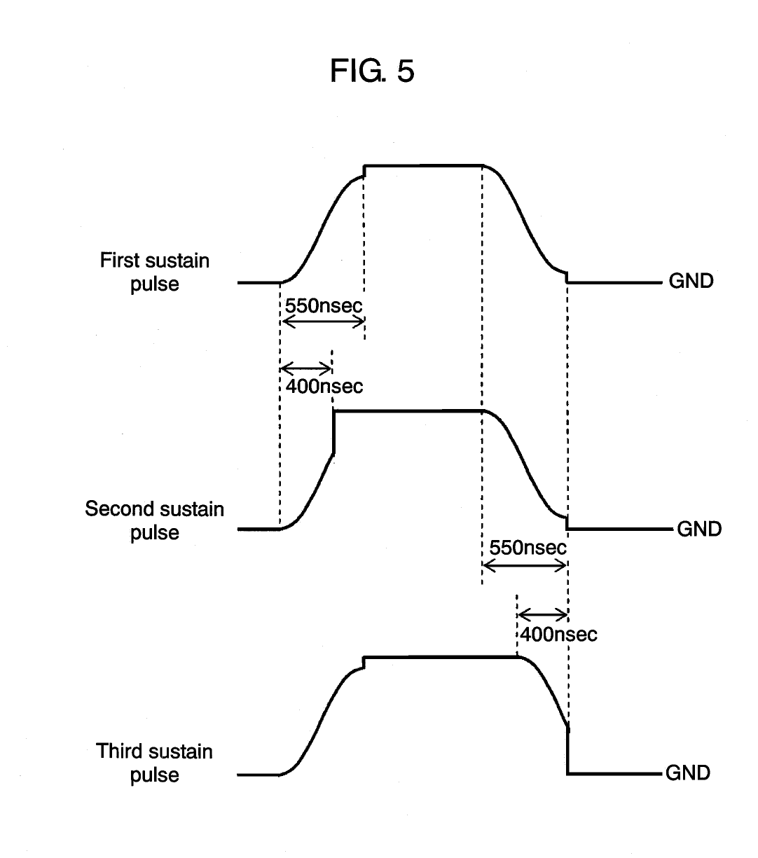

FIG. 5 is a diagram schematically showing waveforms of the first sustain pulse, the second sustain pulse, and the third sustain pulse of the first exemplary embodiment of the present invention. In the following descriptions of the sustain pulses, “rise time” and “fall time” are the periods during which power recovery circuit 110 or power recovery circuit 210 to be described later is operated to cause the sustain pulses to rise or fall. The case where power recovery circuit 110 or power recovery circuit 210 is operated for a short period is referred to as “steep”. The case where the circuit is operated for a long period is referred to as “gentle”. In this exemplary embodiment, each of the rise time and fall time of the first sustain pulse, i.e. a reference pulse, is approximately 550 ns. The rise time of the second sustain pulse is approximately 400 ns. The fall time of the third sustain pulse is approximately 400 ns. Thus, the second sustain pulse has a steeper rise than the first sustain pulse and the third sustain pulse. The third sustain pulse has a steeper fall than the first sustain pulse and the second sustain pulse.

Next, a description is provided of the application of these first sustain pulse, second sustain pulse, and third sustain pulse to the display electrode pairs.

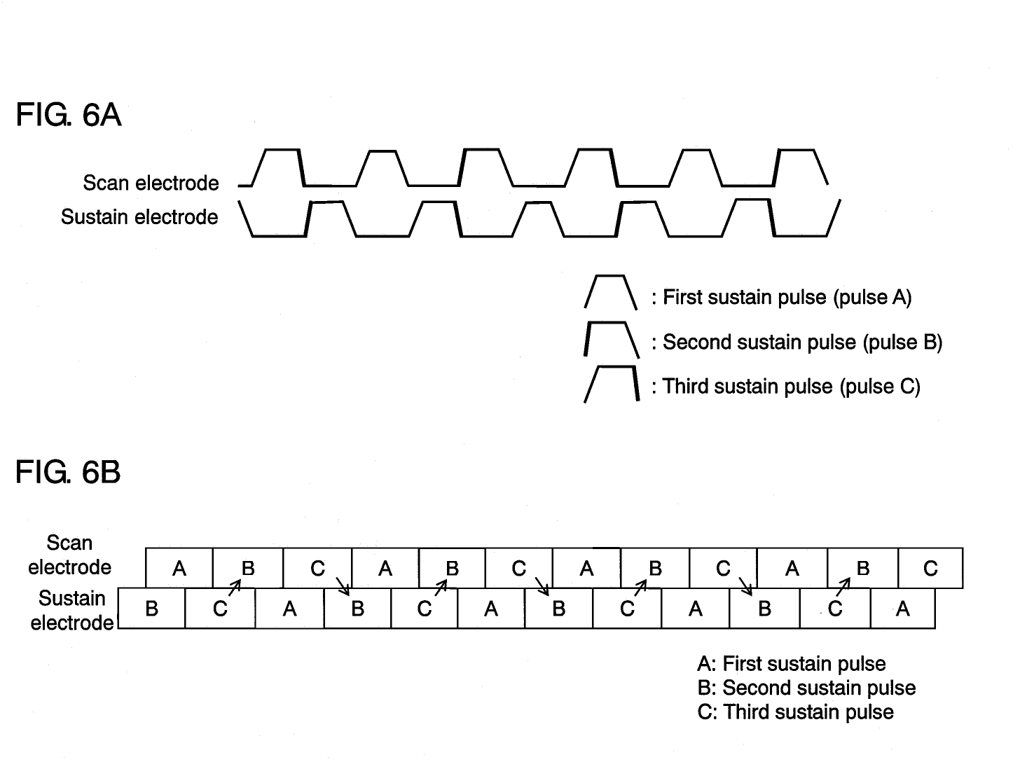

FIGS. 6A and 6B are schematic diagrams showing a generation order of the first sustain pulses, the second sustain pulses, and the third sustain pulses in a sustain period of the first exemplary embodiment. To facilitate understanding of the generation order of the three kinds of sustain pulses, FIG. 6B shows the first sustain pulse, the second pulse, and the third pulse as “pulse A”, “pulse B”, and “pulse C”, respectively.

In this exemplary embodiment, as shown in FIGS. 6A and 6B, three kinds of sustain pulses are alternately generated and switched to be applied to the electrodes of each display electrode pair 28, in a sustain period. The three kinds of pulses include: the first sustain pulse (pulse A), i.e. a reference pulse; the second sustain pulse (pulse B) having a steeper rise than the first sustain pulse (pulse A) and the third sustain pulse (pulse C); and the third pulse (pulse C) having a steeper fall than the first sustain pulse (pulse A) and the second sustain pulse (pulse C). At this time, as shown by the arrows in FIG. 6B, immediately after the third sustain pulse (pulse C) is applied to one electrode of each display electrode pair 28, the second sustain pulse (pulse B) is applied to the other electrode of each display electrode pair 28. The driving circuit for generating these sustain pulses and the sustain pulse generation are detailed later. This driving circuit includes a power recovery circuit and a clamp circuit, and controlling the driving time of the power recovery circuit controls the rising and falling of the sustain pulses.

The inventors of the present invention have found that the use of such a panel driving method of this exemplary embodiment can reduces variations in the emission luminance between the discharge cells, and allows stable addressing discharge without increasing the voltage necessary for addressing.

The light-emitting rate of the respective discharge cells varies with the display image. Thus, the driving load of the display electrode pairs varies with the display image. At this time, a high impedance of the voltage applying means causes variations in the rising waveform of the sustain pulses, thus causing variations in the timing (discharge-starting time) at which discharge occurs in the respective discharge cells.

On the other hand, a panel having a higher xenon partial pressure to improve the emission luminance has a higher discharge-starting voltage across the electrodes of each display electrode pair. This phenomenon tends to further increase variations in the discharge generation timing.

The difference in the discharge generation timing between adjacent discharge cells as described above causes differences in emission intensity between a discharge cell generating discharge earlier and a discharge cell generating discharge later. This difference may cause variations in the emission luminance on the display surface of the panel. The causes of these variations are considered as follows. The influence exerted by the discharge cell generating discharge earlier on the discharge cell generating discharge later decreases the wall charge and weakens the discharge in the latter cell. In another case, when a discharge having started once is stopped by the influence of the adjacent cell and restarted by increases in applied voltage, such a discharge can be weak.

The brightness of the discharge cells is correlated with the number of sustaining discharges in one field period and the emission intensity of each sustaining discharge. Thus, occurrence of these phenomena causes variations in the luminance between the discharge cells. These phenomena are more conspicuous in a sustain pulse having a gentler rise.

Further, in a sustain period, continuous sustaining discharge is generated by using the wall voltage formed by a sustaining discharge operation, for the succeeding sustaining discharge operation. The emission intensity of the succeeding sustaining discharge operation depends on the wall voltage formed by the preceding sustaining discharge operation. In other words, after unstable sustaining discharge incapable of forming sufficient wall voltage occurs once, unstable sustaining discharge may continue.

To address this problem, causing discharge in a steep change in voltage is effective. Generation of discharge in a steep voltage change accommodates variations in the discharge-starting voltage and decreases variations in the discharge generation timing between the respective discharge cells. Thus, variations in the luminance can be inhibited. Then, the wall voltage formed by sustaining discharge is made uniform, and the sustaining discharge to be caused thereafter can be stabilized.

The second sustain pulse (pulse B) of this exemplary embodiment is a sustain pulse for inhibiting variations in the luminance between the respective discharge cells that result from variations in the discharge generation timing between the respective discharge cells. In other words, the second sustain pulse having a steeper rise than the first sustain pulse (pulse A), i.e. a reference pulse, is generated once every three times so that one out of three sustaining discharge operations is generated in a steep change in the voltage applied to the panel. This application accommodates variations in the discharge-starting voltage, and synchronizes the discharge generation timings of the discharge cells, and thus reduces variations in the luminance between the discharge cells.

However, shortening the rise time of the sustain pulse to provide a steeper rise generates sustaining discharge stronger than that in the other cases. Experimental results show that such strong sustaining discharge generates differences in the emission intensity that result from a cause other than the different sustaining discharge timings.

Generation of strong discharge increases the discharge current, thus increasing the voltage drop caused by the impedance along the path of the discharge current. Because the light-emitting rate of display electrode pairs varies with the display image, the amount of discharge current is different between the respective display electrode pairs. Thus, the amount of voltage drop also varies with the display electrode pair, thereby causing differences in the voltage applied to the respective discharge cells. Further, it is confirmed that changes in the amount of current cause not only the voltage drop but also waveform changes in the rise of the scan pulse voltage probably resulting from the interelectrode capacitance or the like. It is also confirmed that the waveform changes in the rise have influence on the generation of discharge. This influence can cause differences in the emission intensity between a portion having low light-emitting rates and a portion having high light-emitting rates.

Thus, it is obvious that shortening the rise time of a sustain pulse and providing a steep rise to synchronize the sustaining discharge timings generates the emission intensity difference resulting from a cause other than the different sustaining discharge timings.

Strong sustaining discharge also decreases the wall charge on the unlit discharge cells adjacent to the discharge cells having generated the strong discharge. As described above, in a sub-field for performing the selective initializing operation, the initializing discharge is performed selectively in the discharge cells having performed sustaining operation in the sustain period of the preceding sub-filed. Thus, in the discharge cells having generated no sustaining discharge in the preceding sub-field, no discharge occurs, and the wall charge at the completion of the setup period of the preceding sub-field is used for addressing.

For this reason, when the wall discharge on the unlit discharge cells is decreased by the strong sustaining discharge generated in the adjacent discharge cells, the wall voltage necessary for addressing in the succeeding sub-field for performing the selective initializing operation is insufficient and discharge failures may occur in the addressing operation. In a high-definition panel having a larger number of electrodes formed therein, the pulse width of the address pulse voltage must be reduced so that the time necessary for addressing is not increased. Thus, the discharge tends to be unstable. Further, the width of the portion between the discharge cells is reduced with miniaturization of discharge cells. Thus, it is more likely that the wall charge is deprived and discharge failures occur under the above conditions.

To address this problem, weakening the intensity of the sustaining discharge generated by the second sustain pulse (pulse B) is effective.

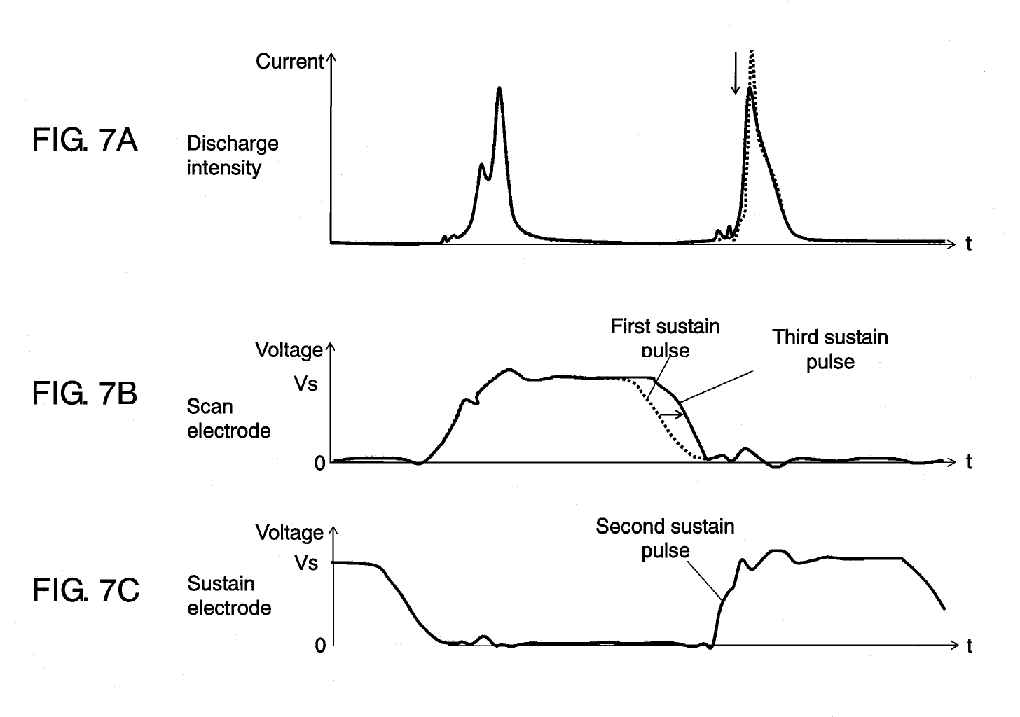

FIGS. 7A, 7B, and 7C are diagrams of waveforms schematically showing results of an experiment on sustaining discharge intensity in accordance with the first exemplary embodiment. FIG. 7A is a diagram of a waveform showing the discharge intensity in the magnitude of current. FIG. 7B is a diagram of a voltage waveform of sustain pulses applied to scan electrodes SC1 to SCn. FIG. 7C is a diagram of a voltage waveform of a sustain pulse applied to sustain electrodes SU1 to SUn.

According to the experiment, the discharge (having a waveform shown by the solid line in FIG. 7A) caused by application of the second sustain pulse (pulse B) to sustain electrodes SU1 to SUn as shown in FIG. 7C after application of the third sustain pulse (pulse C) to scan electrodes SC1 to SCn as shown by the solid line in FIG. 7B is weaker than the discharge (having a waveform shown by the broken line in FIG. 7A) caused by application of the second sustain pulse (pulse B) to sustain electrodes SU 1 to SUn after application of the first sustain pulse (pulse A) to scan electrodes SC1 to SCn as shown by the broken line in FIG. 7B. Though not shown, the experiment in which the second sustain pulse is applied to scan electrodes SC1 to SCn and the first or third sustain pulse to sustain electrodes SU1 to SUn in the opposite manner also shows the same result.

In this manner, the experiments show that the application of a sustain pulse having a steeper fall immediately before the application of the second sustain pulse (pulse B) can exert an influence on the succeeding discharge to be generated by the second sustain pulse (B) and weaken the discharge.

The third sustain pulse (pulse C) of this exemplary embodiment is a sustain pulse for weakening the sustaining discharge to be generated by the second sustain pulse (pulse B). In other words, in the structure of this exemplary embodiment, immediately after the third sustain pulse (pulse C) having a steeper fall than the first sustain pulse (pulse A), i.e. a reference pulse, is applied to one electrode of each display electrode pair 28, the second sustain pulse (pulse B) is applied to the other electrode of each display electrode pair 28.

This structure can weaken the sustaining discharge to be generated by the second sustain pulse (pulse B), inhibit the drop of the voltage applied to the discharge cells during generation of discharge and waveform changes in the rise of the second sustain pulse (pulse B), and decrease the emission intensity difference. Further, this structure decreases the influence on the wall charge in the adjacent unlit discharge cells, and allows stable addressing discharge in the address period of the succeeding sub-field without increasing the voltage necessary for addressing.

Further, it is also confirmed that controlling the fall time of the third sustain pulse (pulse C) allows controlling the intensity of the discharge to be generated by the second sustain pulse (pulse B). Specifically, shortening the driving time of the power recovery circuit to make the steeper fall in the third sustain pulse (pulse C) can decrease the intensity of the discharge to be generated by the second sustain pulse (pulse B). The experimental results show that this sustain pulse is preferably set to have a fall time of 300 ns or longer for practical use. However, this exemplary embodiment is not limited to these values. It is preferable to set optimum values according to the characteristics of the panel and the specifications of the plasma display device.

As described above, in this exemplary embodiment, generating the second sustain pulse (pulse B) having a stepper rise once every three times can synchronize the discharge generation timings of the respective discharge cells and decrease variations in the luminance between the discharge cells. Further, the application of the second sustain pulse (pulse B) to one electrode of each display electrode pair 28 immediately after the application of the third sustain pulse (pulse C) to the other electrode of each display electrode pair 28 can weaken the discharge to be generated by the second sustain pulse (pulse B) and decrease the influence on the adjacent discharge cells. Thus, stable addressing discharge can be generated without increasing voltage necessary for addressing.

Next, a description is provided of a circuit structure of a plasma display device of this exemplary embodiment.

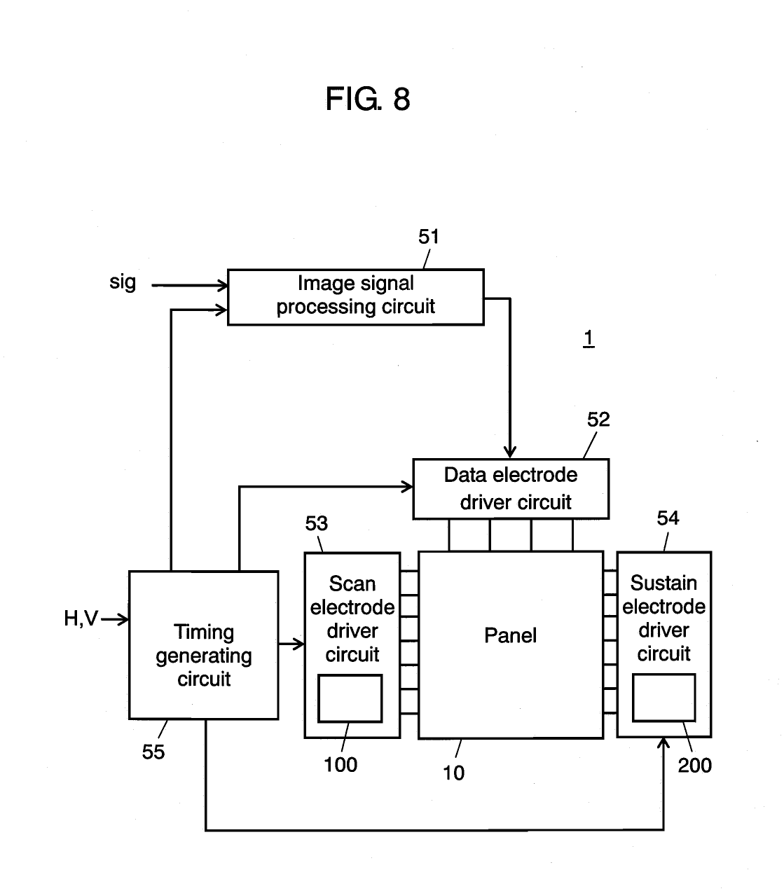

FIG. 8 is a circuit block diagram of a plasma display device in accordance with the first exemplary embodiment. Plasma display device 1 includes panel 10, image signal processing circuit 51, data electrode driver circuit 52, scan electrode driver circuit 53, sustain electrode driver circuit 54, timing generating circuit 55, and power supply circuits (not shown) for supplying necessary power to each circuit block.

Image signal processing circuit 51 converts supplied image signal sig into image data showing whether the discharge cells are to be lit or not for each sub-field. Data electrode driver circuit 52 converts the image data for each sub-field into signals corresponding to respective data electrodes D1 to Dm, and drives respective data electrodes D1 to Dm.

Timing generating circuit 55 generates various kinds of timing signals for controlling the operation of each circuit block based on horizontal synchronizing signal H and vertical synchronizing signal V, and supplies the timing signals to each circuit block. As described above, in this exemplary embodiment, in the sustain period, three kinds of sustain pulses are generated and switched to be applied to scan electrodes SC1 to SCn and sustain electrodes SU1 to SUn. The timing signals corresponding to the sustain pulses are supplied to scan electrode driver circuit 53 and sustain electrode driver circuit 54. This structure allows control of reducing variations in the emission luminance.

Scan electrode driver circuit 53 includes sustain pulse generating circuit 100 for generating sustain pulses to be applied to scan electrodes SC1 to SCn in the sustain period, and drives respective scan electrodes SC1 to SCn according to the timing signals. Sustain electrode driver circuit 54 includes a circuit for applying voltage Ve1 to sustain electrodes SU1 to SUn in the setup period, and sustain pulse generating circuit 200 for generating sustain pulses to be applied to sustain electrodes SU1 to SUn in the sustain period, and drives respective sustain electrodes SU1 to SUn according to the timing signals.

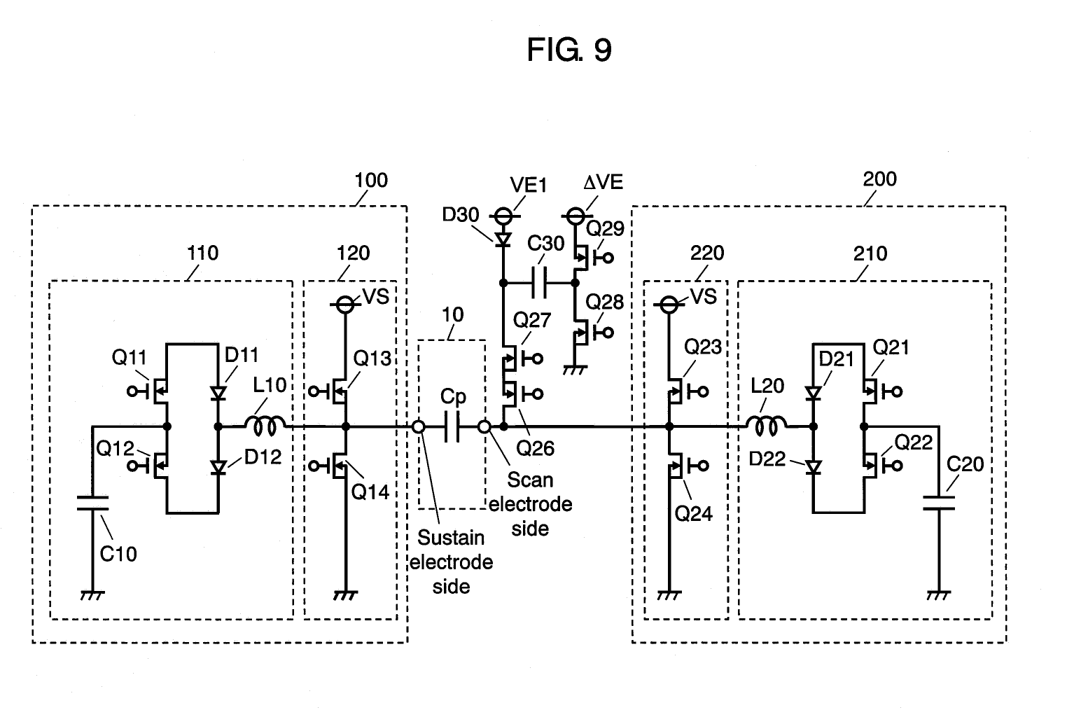

Next, a description is provided of the details and operation of sustain pulse generating circuits 100 and 200. FIG. 9 is a circuit diagram of sustain pulse generating circuits 100 and 200 in accordance with the first exemplary embodiment of the present invention. In FIG. 9, the interelectrode capacitance of panel 10 is shown as Cp, and the circuits for generating scan pulses and setup voltage waveforms are omitted.

Sustain pulse generating circuit 100 includes power recovery circuit 110 and clamp circuit 120.

Power recovery circuit 110 includes power recovery capacitor C10, switching elements Q11 and Q12, blocking diodes D11 and D12, and resonance inductor L10. Clamp circuit 120 includes switching element Q13 for clamping scan electrodes SC1 to SCn to power supply VS having a voltage of Vs, and switching element Q14 for clamping scan electrodes SC1 to SCn to ground potential. Power recovery circuit 110 and clamp circuit 120 are coupled to scan electrodes SC1 to SCn, i.e. one end of interelectrode capacitance Cp of panel 10, through a scan pulse generating circuit (not shown because the circuit is short-circuited during the sustain period).

Power recovery circuit 110 causes LC resonance between interelectrode capacitance Cp and inductor L10 to make sustain pulses rise and fall. In the rise of a sustain pulse, the electric charge stored in power recovery capacitor C10 is moved to interelectrode capacitance Cp through switching element Q11, diode D11, and inductor L10. In the fall of the sustain pulse, the electric charge stored in interelectrode capacitance Cp is returned to power recovery capacitor C10 through inductor L10, diode D12, and switching element Q12. Thus, sustain pulses are applied to scan electrodes SC1 to SCn. In this manner, power recovery circuit 110 drives scan electrodes SC1 to SCn using LC resonance without power supplied from a power supply, and thus power consumption is 0 in an ideal situation. Power recovery capacitor C10 has capacitance sufficiently larger than interelectrode capacitance Cp, works as a power supply of power recovery circuit 110, and is charged to have a voltage of approximately Vs/2, i.e. a half of voltage Vs of power supply VS. The potential of capacitor C10, i.e. recovery potential, changes according to the recovery efficiency of the electric charge stored in interelectrode capacitance Cp, specifically the slope of the sustain pulse in the fall. In other words, with a steeper fall, the recovery efficiency and thus the recovery potential are lower.

Voltage clamp circuit 120 allows scan electrodes SC1 to SCn to be coupled to power supply VS through switching element Q13 and clamped to voltage Vs. Further, the voltage clamp circuit allows scan electrodes SC1 to SCn to be grounded through switching element Q14 and clamped to 0 (V). Thus, voltage clamp circuit 120 drives scan electrodes SC1 to SCn. For this reason, the impedance of voltage clamp circuit 120 during application of voltage is small and thus a large discharge current can be supplied by sustaining discharge in a stable manner.

In this manner, sustain pulse generating circuit 100 controls switching elements Q11, Q12, Q13, and Q14 so that sustain pulses are applied to scan electrodes SC1 to SCn using power recovery circuit 110 and voltage clamp circuit 120. These switching elements can be made of known devices, such as a MOSFET and IGBT.

Sustain pulse generating circuit 200 includes power recovery circuit 210 and clamp circuit 220. The power recovery circuit includes power recovery capacitor C20, switching elements Q21 and Q22, blocking diodes D21 and D22, and resonance inductor L20. The clamp circuit includes switching element Q23 for clamping sustain electrodes SU1 to SUn to voltage Vs, and switching element Q24 for clamping sustain electrodes SU1 to SUn to ground potential, and is coupled to sustain electrodes SU1 to SUn, i.e. one end of interelectrode capacitance Cp of panel 10. The operation of sustain pulse generating circuit 200 is similar to that of sustain pulse generating circuit 100, and the description thereof is omitted.

FIG. 9 also shows power supply VE1 that generates voltage Ve1 for alleviating potential difference between the electrodes of each display electrode pair, switching elements Q26 and Q27 for applying voltage Ve1 to sustain electrodes SU1 to SUn, power supply ΔVE for generating voltage ΔVe, blocking diode D30, capacitor C30, and switching elements Q28 and Q29 for adding voltage ΔVe to voltage Ve1 to make voltage Ve2.

The period of LC resonance between inductor L10 of power recovery circuit 110 and interelectrode capacitance Cp of panel 10, and the period of LC resonance (hereinafter “resonance period”) between inductor L20 of power recovery circuit 210 and interelectrode capacitance Cp thereof can be obtained using formula “2π√(LCp)” where the inductance of each of inductors L10 and L20 is L. In this exemplary embodiment, inductors L10 and L20 are set so that the resonance periods in power recovery circuits 110 and 210 are approximately 1,100 ns.

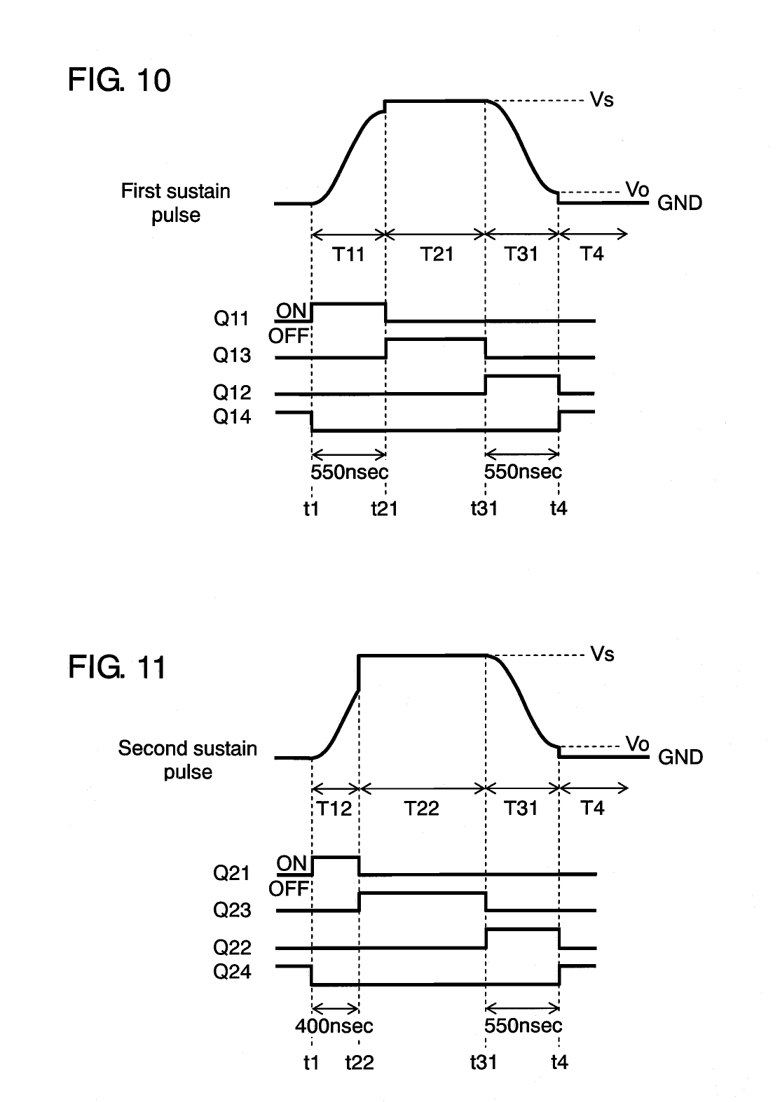

Next, a description is provided of the operation of the sustain pulse generating circuits for generating the first sustain pulse (pulse A), the second sustain pulse (pulse B), and the third sustain pulse (pulse C), with reference to FIGS. 10 through 12.

First, a description is provided of the first sustain pulse (pulse A), i.e. a reference pulse. FIG. 10 is a diagram showing a waveform of the first sustain pulse (pulse A) of the first exemplary embodiment. Now, in this embodiment, a description is provided of sustain pulse generating circuit 100 on the side of scan electrodes SC1 to SCn. Sustain pulse generating circuit 200 on the side of sustain electrodes SU1 to SUn has an identical circuit structure and performs similar operation. In the following description of the operation of the switching elements, bringing the element into conduction is indicated as ON and ceasing conduction as OFF.

### (Period T11)

Switching element Q11 is turned on at time t1. Then, electric charge starts moving from power recovery capacitor C10 to scan electrodes SC1 to SCn through switching element Q11, diode D11, and inductor L10, thereby increasing the voltage of scan electrode SC1 to SCn. Because inductor L10 and interelectrode capacitor Cp forms a resonance circuit, the voltage of scan electrodes SC1 to SCn increases near Vs when time approximately a half the resonance period has elapsed since time t1. As described above, in this exemplary embodiment, the period of resonance between inductor L10 and interelectrode capacitance Cp is set to approximately 1,100 ns. For the first sustain pulse (pulse A) to be applied to scan electrodes SC1 to SCn, the rise time thereof, i.e. period T11 from time t1 to time t21, is set to approximately 550 ns, i.e. a half the resonance period.

### (Period T21)

Next, at time t21 when approximately a half of the resonance period has elapsed since time t1, switching element Q13 is turned on.

Then, scan electrodes SC1 to SCn are coupled to power supply VS through switching element Q13 and thus clamped to voltage Vs. When scan electrodes SC1 to SCn are clamped to voltage Vs, the voltage difference between scan electrodes SC1 to SCn and sustain electrodes SU1 to SUn in the discharge cells having generated addressing discharge exceeds the discharge-starting voltage, thereby causing sustaining discharge. When this period for clamping the electrodes to power supply VS is too short, because the wall voltage formed with the sustaining discharge is insufficient, sustaining discharge cannot be generated continuously. In contrast, when the period is too long, because the cycle period of the sustain pulses is too long, the necessary number of sustain pulses cannot be applied to display electrode pairs 28. For this reason, preferably, the period for clamping the electrodes to power supply VS is set approximately from 800 ns to 1,500 ns for practical use. In this exemplary embodiment, period T21 is set to approximately 1,000 ns.

### (Period T31)

At time t31, switching element Q12 is turned on. Then, electric charge starts moving from scan electrodes SC1 to SCn to capacitor C10 through inductor L10, diode D12, and switching element Q12, thereby decreasing the voltage of scan electrodes SC1 to SCn. As described above, the period of resonance between inductor L10 and interelectrode capacitance Cp is set to approximately 1,100 ns. For the first sustain pulse (pulse A) to be applied to scan electrodes SC1 to SCn, the fall time thereof, i.e. period T31 from time t31 to time t4, is set to approximately 550 ns, i.e. a half the resonance period.

### (Period T4)

Next, at time t4 when approximately a half of the resonance period has elapsed since time t31, switching element Q14 is turned on. Then, scan electrodes SC1 to SCn are directly grounded through switching element Q14, and thus clamped to voltage 0 (V).

In this manner, each of the rise time and fall time of the first sustain pulse (pulse A) is set to approximately 550 ns, which is about a half of approximately 1,100 ns, i.e. the period of resonance between inductor L10 and interelectrode capacitance Cp.

Next, a description is provided of the second sustain pulse (pulse B) having a steeper rise than the first sustain pulse (pulse A) and the third sustain pulse (pulse C). FIG. 11 is a diagram showing a waveform of the second sustain pulse (pulse B) of the first exemplary embodiment. FIG. 11 shows a case where the second sustain pulse (pulse B) is applied to sustain electrodes SU1 to SUn, as an example. With reference to FIG. 11, a description is provided of sustain pulse generating circuit 200 on the side of sustain electrodes SU1 to SUn. Sustain pulse generating circuit 100 on the side of scan electrodes SC1 to SCn performs similar operation.

### (Period T12)

Switching element Q21 is turned on at time t1. Then, electric charge starts moving from power recovery capacitor C20 to sustain electrodes SU1 to SUn through switching element Q21, diode D21, and inductor L20, thereby increasing the voltage of sustain electrodes SU1 to SUn. For the second sustain pulse (pulse B) to be applied to sustain electrodes SU1 to SUn, the rise time thereof, i.e. period T12 from time t1 to time t22, is set to approximately 400 ns, which is shorter than a half the resonance period.

### (Period T22)

At time t22, switching element Q23 is turned on. Then, sustain electrodes SU1 to SUn are coupled directly to power supply VS through switching element Q23 and thus clamped to voltage Vs. Thereby, sustain discharge occurs. For the second sustain pulse (pulse B), period T22 is set to approximately 1,150 ns, which is longer than period T21 by the rise time set shorter than that of the first sustain pulse (pulse A). Thus, the pulse widths from the rise to the fall are the same for the first sustain pulse (pulse A) and the second sustain pulse (pulse B).

For the second sustain pulse (pulse B), the operation in period T31 and period T4 is the same as that of the first sustain pulse (pulse A). Thus, the description thereof is omitted.

In this manner, the rise time of the second sustain pulse (pulse B) is set to approximately 400 ns, which is shorter than the rise time of the first sustain pulse (pulse A). Thus, the second sustain pulse has a steeper rise than the first sustain pulse (pulse A).

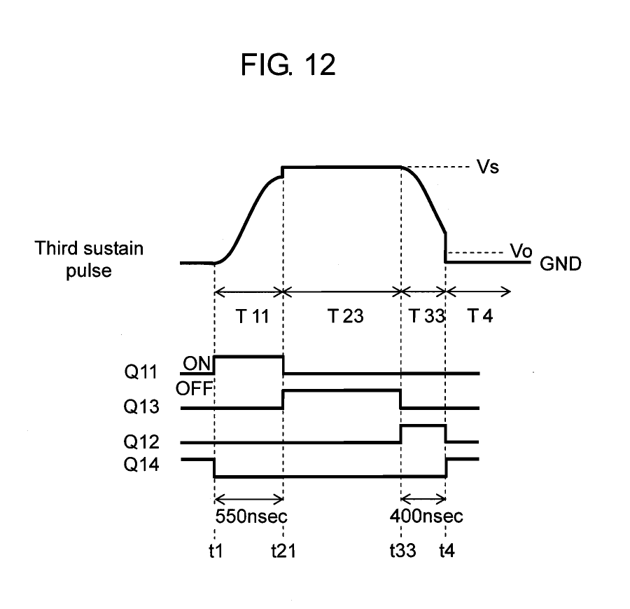

Next, a description is provided of the third sustain pulse (pulse C) having a steeper fall than the first sustain pulse (pulse A) and the second sustain pulse (pulse C). FIG. 12 is a diagram showing a waveform of the third sustain pulse (pulse C) of the first exemplary embodiment. FIG. 12 shows a case where the third sustain pulse (pulse C) is applied to scan electrodes SC1 to SCn, as an example. With reference to FIG. 12, a description is provided of sustain pulse generating circuit 100 on the side of scan electrodes SC1 to SCn. Sustain pulse generating circuit 200 on the side of sustain electrodes 23 performs similar operation.

### (Period T11)

Switching element Q11 is turned on at time t1. Then, electric charge starts moving from power recovery capacitor C10 to scan electrodes SC1 to SCn through switching element Q11, diode D11, and inductor L10, thereby increasing the voltage of scan electrode SC1 to SCn. For the third sustain pulse (pulse C), period T11 from time t1 to time t21 is set to approximately 550 ns, like the first sustain pulse (pulse A).

### (Period T23)

At time t21, switching element Q13 is turned on. Then, scan electrodes SC1 to SCn are coupled directly to power supply VS through switching element Q13 and thus clamped to voltage Vs. Thereby, sustain discharge occurs. For the third sustain pulse (pulse C), succeeding period T33, i.e. the fall time, is set shorter than the fall time of the first sustain pulse (pulse A). Thus, period T23 is set to approximately 1,150 ns, which is longer than period T21 by the shorter fall time, so that the cycle length from the rise to the fall is the same for the first sustain pulse (pulse A) and the third sustain pulse (pulse C).

### (Period T33)

At time t33, switching element Q12 is turned on. Then, electric charge starts moving from scan electrodes SC1 to SCn to capacitor C10 through inductor L10, diode D12, and switching element Q12, thereby decreasing the voltage of scan electrodes SC1 to SCn. For the third sustain pulse (pulse C) to be applied to scan electrodes SC1 to SCn, the fall time thereof, i.e. period T33 from time t33 to time t4, is set to approximately 400 ns, which is shorter than a half the resonance period.

For the third sustain pulse (pulse C), the operation in period T4 is the same as the operation of the first sustain pulse (pulse A). Thus, the description thereof is omitted.

In this manner, the fall time of the third sustain pulse (pulse C) is set to approximately 400 ns, which is shorter than the fall time of the first sustain pulse (pulse A). Thus, the third sustain pulse has a steeper fall than the first sustain pulse (pulse A).

Those described above are the operation of the sustain pulse generating circuits for generating the first sustain pulse (pulse A), the second sustain pulse (pulse B), and the third sustain pulse (pulse C) in this exemplary embodiment. As described above, three kinds of sustain pulses having different rises and falls are generated by controlling the period during which switching elements for controlling the voltage application of the power recovery circuit to the display electrode pairs (switching elements Q11, Q21, Q12, and Q22) are kept ON.

As described above, in this exemplary embodiment, generating the second sustain pulses (pulse B) having a stepper rise once every three times, for example, can synchronize the discharge generation timings of the discharge cells and reduce the variations in the luminance between the discharge cells. Further, immediately after the third sustain pulse (pulse C) having a steeper fall is applied to one electrode of each display electrode pair 28, the second sustain pulse (pulse B) is applied to the other electrode of each display electrode pair 28. This application weakens the discharge to be generated by the second sustain pulse (pulse B), reduces the influence on the adjacent discharge cells, and allows stable addressing discharge without increasing the voltage necessary for addressing.

In this exemplary embodiment, a description is provided of a structure in which the first sustain pulses (pulse A), the second sustain pulses (pulse B), and the third sustain pulses (pulse C) are generated at a rate of approximately 1:1:1. However, the present invention is not limited to this structure, and can be of another structure. Next, examples of the other structure are described.

### Second Exemplary Embodiment

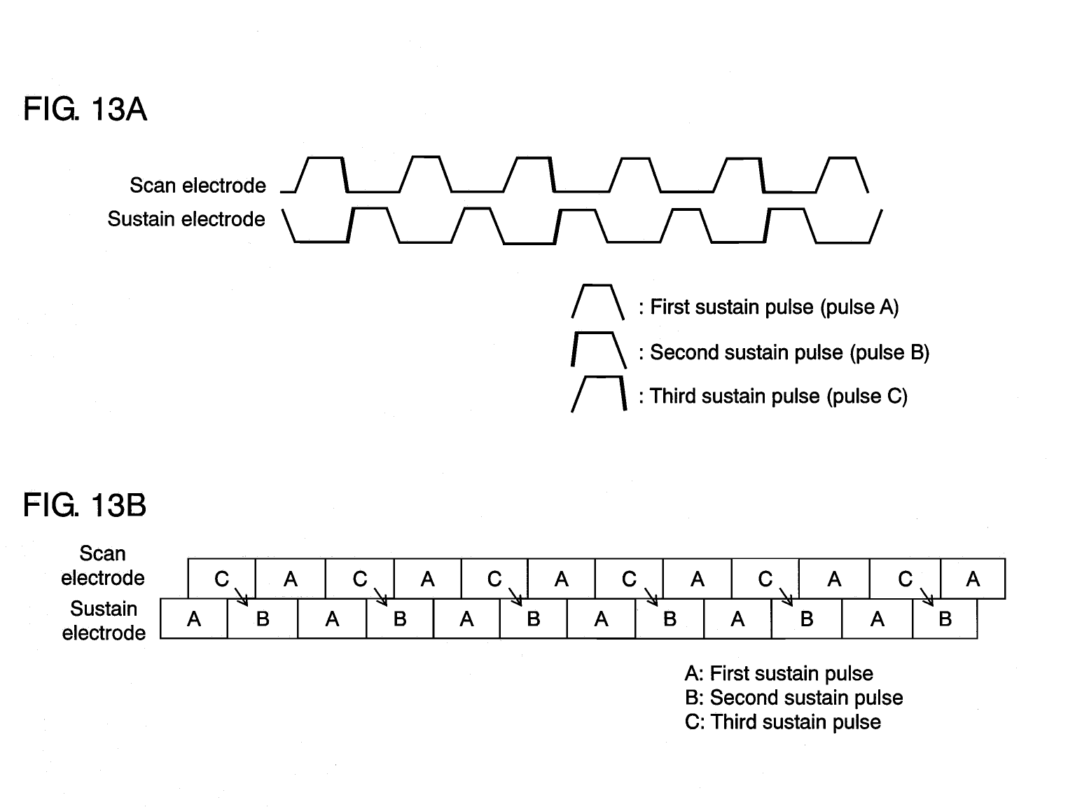

FIGS. 13A and 13B are schematic diagrams showing a generation order of first sustain pulses, second sustain pulses, and third sustain pulses in a sustain period in accordance with the second exemplary embodiment of the present invention. Like FIG. 6B, FIG. 13B shows the first sustain pulse, the second sustain pulse, and the third sustain pulse as “pulse A”, “pulse B”, and “pulse C”, respectively, using reference marks.

In this exemplary embodiment, each of the second sustain pulse (pulse B) and the third sustain pulse (pulse C) is generated once every four times so that one out of four sustain discharge operations is performed in a steep change in the voltage applied to the panel. Further, the second sustain pulse (pulse B) is applied to sustain electrodes SU1 to SUn only. The third sustain pulse (pulse C) is applied to scan electrodes SC1 to SCn only. In other words, the first sustain pulse (pulse A) and the third sustain pulse (pulse C) are switched and alternately applied to scan electrodes SC1 to SCn, i.e. one electrode of each display electrode pair 28. The first sustain pulse (pulse A) and the second sustain pulse (pulse B) are switched and alternately applied to sustain electrodes SU1 to SUn, the other electrode of each display electrode pair 28. Thus, as shown by the arrows in FIG. 13B, immediately after the third sustain pulse (pulse C) is applied to scan electrodes SC1 to SCn, the second sustain pulse (pulse B) is applied to sustain electrodes SU1 to SUn. Such operation is performed for the following reason.

It is confirmed that a steep fall of a sustain pulse decreases the power recovery rate of a sustain pulse generating circuit and thus the recovery potential in a power recovery circuit.

The inventors of the present invention have found, through experiments, that the effect of inhibiting variations in the light emission can be improved by making the recovery potential in sustain pulse generating circuit 200 on the side of sustain electrodes SU1 to SUn higher than the recovery potential in sustain pulse generating circuit 100 on the side of scan electrodes SC1 to SCn.

For this reason, in the structure of this exemplary embodiment, the second sustain pulses (pulse B) are applied to sustain electrodes SU1 to SUn only, and the third sustain pulses (pulse C) are applied to scan electrodes SC1 to SCn only. Then, immediately after the third sustain pulse (pulse C) is applied to scan electrodes SC1 to SCn, the second sustain pulse (pulse B) is applied to sustain electrodes SU1 to SUn. This structure can make the recovery potential in sustain pulse generating circuit 200 on the side of sustain electrodes SU1 to SUn higher than the recovery potential in sustain pulse generating circuit 100 on the side of scan electrodes SC1 to SCn, and further reduce variations in the light emission between the discharge cells.

### Third Exemplary Embodiment

The present invention is not limited to the structures that have the generation orders of the first sustain pulses (pulse A), the second sustain pulses (pulse B), and the third sustain pulses (pulse C) shown in the first and second exemplary embodiments. Another structure can also be used.

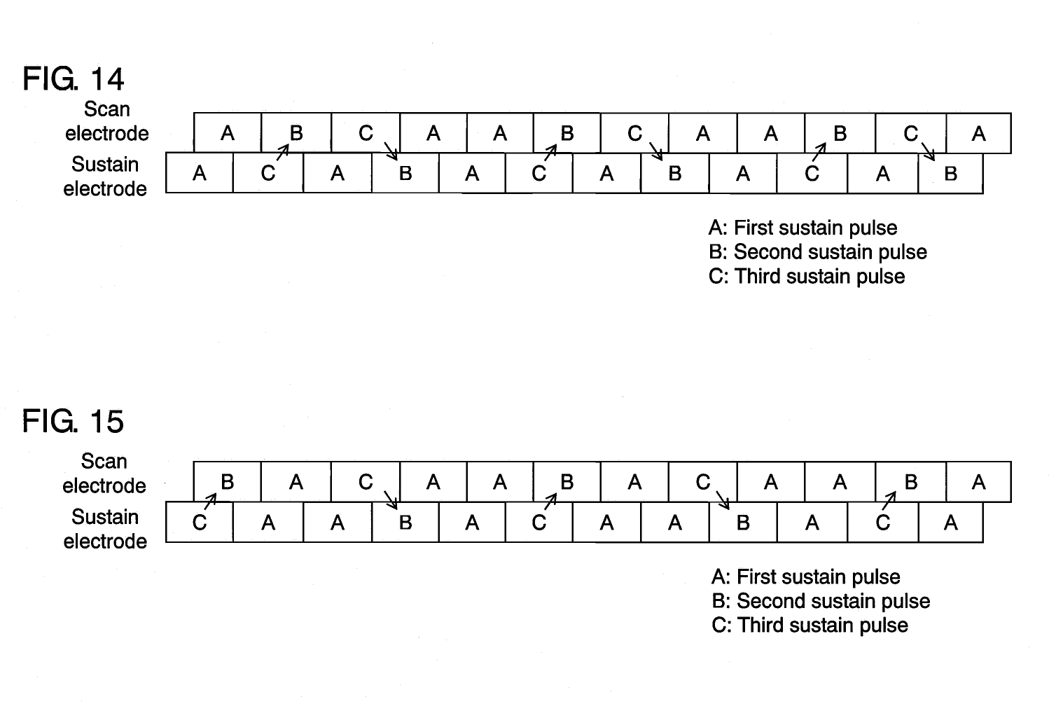

FIGS. 14 through 17 are schematic diagrams showing examples of the generation order of sustain pulses in accordance with the third exemplary embodiment of the present invention.

For example, as shown in FIG. 14, the first sustain pulses (pulse A), the second sustain pulses (pulse B), and the third sustain pulses (pulse C) may be generated at a rate of approximate 2:1:1. Further, the sustain pulses may be generated in the following order: the first sustain pulse (pulse A), the first sustain pulse (pulse A), the first sustain pulse (pulse A), the third sustain pulse (pulse C), the second sustain pulse (pulse B), the first sustain pulse (pulse A), the third sustain pulse (pulse C), the second sustain pulse (pulse B), the first sustain pulse (pulse A), and so on. In this structure, the generation rate of the respective sustain pulses are the same as that in the example of the structure shown in FIGS. 13A and 13B. However, in the generation order of FIG. 14, the electrodes to which the second sustain pulses (pulse B) are applied and the electrodes to which the third sustain pulses (pulse C) are applied can alternate.

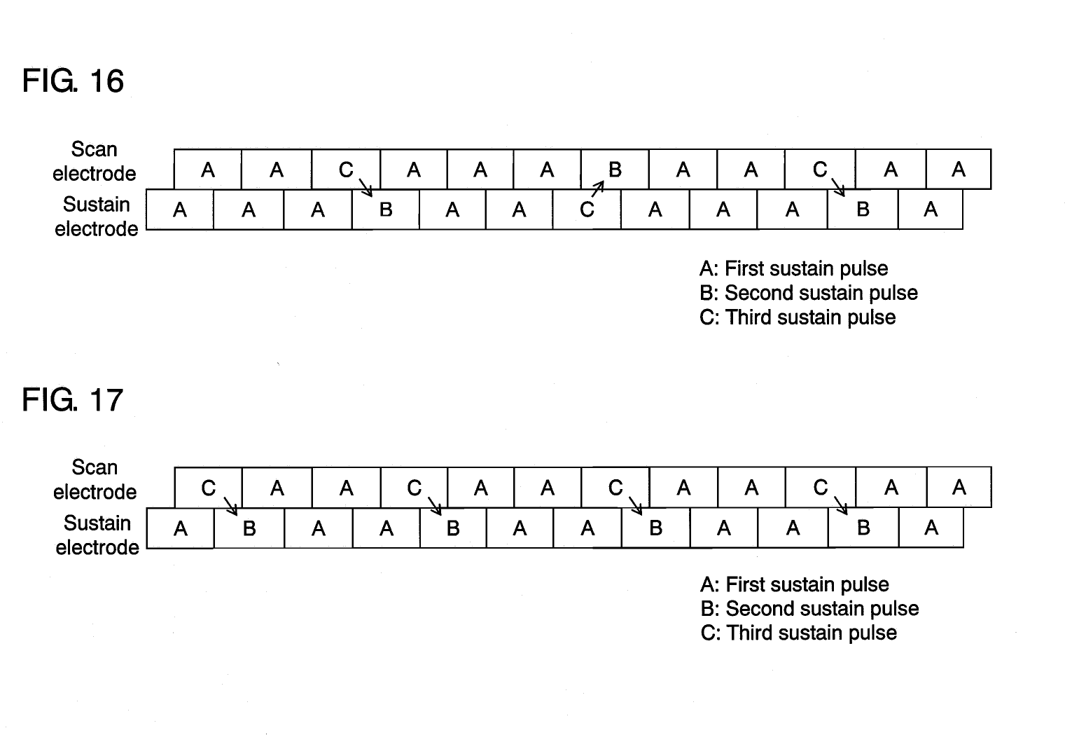

Alternatively, as shown in FIG. 15, the first sustain pulses (pulse A), the second sustain pulses (pulse B), and the third sustain pulses (pulse C) may be generated at a rate of approximately 3:1:1. Alternatively, as shown in FIG. 16, the first sustain pulses (pulse A), the second sustain pulses (pulse B), and the third sustain pulses (pulse C) may be generated at a rate of approximately 5:1:1. These structures are examples in which the electrodes to which the second sustain pulses (pulse B) are applied and the electrodes to which the third sustain pulses (pulse C) are applied alternate. However, like the second exemplary embodiment, the second sustain pulses (pulse B) may only be applied to one electrode of each display electrode pair (sustain electrodes SU1 to SUn in this embodiment) and the third sustain pulses (pulse C) may only be applied to the other electrode of each display electrode pair (scan electrodes SC1 to SCn in this embodiment).

For example, as shown in FIG. 17, the first sustain pulses (pulse A), the second sustain pulses (pulse B), and the third sustain pulses (pulse C) are generated at a rate of approximate 4:1:1. Further, the sustain pulses are generated in the following order: the first sustain pulse (pulse A), the first sustain pulse (pulse A), the first sustain pulse (pulse A), the first sustain pulse (pulse A), the third sustain pulse (pulse C), the second sustain pulse (pulse B), the first sustain pulse (pulse A), and so on. This structure allows the second sustain pulses (pulse B) to be applied only to one electrode of each display electrode pair, and the third sustain pulses (pulse C) to be applied only to the other electrode of each display electrode pair.

Though not shown, other usable examples include a structure in which the first sustain pulses (pulse A), the second sustain pulses (pulse B), and the third sustain pulses (pulse C) are generated at a rate of approximately 6:1:1 and a structure in which the first sustain pulses (pulse A) are generated at a higher frequency.

Preferably, the rates at which the sustain pulses are generated are set to appropriate values according to variations in the luminance between the respective discharge cells, power consumption, and other factors. In any case, stable addressing discharge is performed by application of the second sustain pulse (pulse B) to one electrode of each display electrode pair immediately after application of the third sustain pulses (pulse C) to the other electrode of each display electrode pair. The structure in which the second sustain pulses (pulse B) are applied only to one electrode of each display electrode pair (sustain electrodes SU1 to SUn in this embodiment) and the third sustain pulses (pulse C) are applied only to the other electrode of each display electrode pair (scan electrodes SC1 to SCn in this embodiment) can further reduce variations in the emission luminance.

In these exemplary embodiments, preferably, the above driving operation is not performed in a predetermined period of time in the sustain period (e.g. a period for ten sustain pulses at the end of the sustain period, preferably a period for eight or more pulses to twelve or fewer pulses, for practical use). Experimental results show that the sustain pulses applied at the end of the sustain period have influence on the succeeding addressing. For this reason, the above driving operation is not performed for a period for ten sustain pulses, for example, at the end of the sustain period. Then, during this period, a driving method different from the above driving method is performed to stabilize the succeeding addressing. It is confirmed that such different driving method allows more stable addressing. For the same reason, preferably, the above driving method is not performed in a sub-field in which the total number of sustain pulses in the sustain period is not larger than a predetermined number (a sub-filed in which the total number of the sustain pulses is 10 or smaller, for example). However, these values are only based on the characteristics of a 50-inch diagonal panel having 1,080 display electrode pairs used for the experiments. It is preferable to set optimum values as needed.

In the above descriptions, the examples of these exemplary embodiments of the present invention have a sub-field structure in which the first sub-field is an all-cell initializing sub-field and the second through tenth sub-fields are selective initializing sub-fields. However, the present invention is not limited to this sub-field structure, and the other sub-field structures can be used.

Further, in the descriptions of these exemplary embodiments, identical inductors are used for power supply and power recovery. However, the present invention is not limited to this structure, and a plurality of inductors having different inductances may be switched. Such a structure allows driving operation in which the resonance frequency is switched in the rise and fall of sustain pulses, for example.

In the present invention, the voltage waveform of the last sustain pulse in a sustain period is not limited to the above voltage waveform.

In these exemplary embodiments, the discharge gas has a xenon partial pressure of 10%. However, another xenon partial pressure can be used as long as the rate at which the respective sustain pulses are generated is set according to the panel.

The specific values in these exemplary embodiments of the present invention are based on a 50-inch diagonal panel having 1,080 display electrode pairs, and are only examples. The present invention is not limited to these values. It is preferable to set optimum values according to the characteristics of the panel and the specifications of the plasma display device.

### INDUSTRIAL APPLICABILITY

The present invention can reduce variations in the emission luminance between the discharge cells and improve the quality of displaying images, and thus is useful as a plasma display device and a panel driving method.

1. A plasma display device comprising:
a plasma display panel including a plurality of scan electrodes and a plurality of sustain electrodes for constituting display electrode pairs; and
a sustain pulse generating circuit for generating, in a sustain period, sustain pulses each having a variable slope of a rise or fall, in which a plurality of sub-fields are provided in one field period so that each of the sub-fields includes a setup period, an address period, and the sustain period,
wherein, in the sustain period of at least one of the sub-fields in the one field period, the sustain pulse generating circuit generates and switches at least two kinds of the sustain pulses: one sustain pulse having a steeper fall than another sustain pulse; and the other sustain pulse having a steeper rise than another sustain pulse;
immediately after applying the sustain pulse having the steeper fall to one electrode of each of the electrode pairs, the sustain pulse generating circuit applies the sustain pulse having the steeper rise to an other electrode of each of the electrode pairs.

2. The plasma display device of claim 1, wherein
the sustain pulse generating circuit generates and switches at least three kinds of the sustain pulses: a first sustain pulse, i.e. a reference pulse; a second sustain pulse having a steeper rise than other sustain pulses; and a third pulse having a steeper fall than other sustain pulses, and
in the sustain period of at least one of the sub-fields in the one field period, immediately after applying the third sustain pulse to the one electrode of each of the display electrode pairs, the sustain pulse generating circuit applies the second sustain pulse to the other electrode of each of the display electrode pairs.

3. The plasma display device of claim 2, wherein the sustain pulse generating circuit generates and switches the first sustain pulse, the second sustain pulse, and the third sustain pulse so that the first sustain pulse is generated more frequently than the second sustain pulse and the third sustain pulse.

4. The plasma display device of claim 2, wherein the third sustain pulse is applied only to the one electrode of each of the display electrode pairs and the second sustain pulse is applied only to the other electrode of each of the display electrode pairs.

5. The plasma display device of claim 2, wherein the first sustain pulse and the third sustain pulse are switched and applied to the one electrode of each of the display electrode pairs, and the first sustain pulse and the second sustain pulse are periodically switched and applied to the other electrode of each of the display electrode pairs.

6. A plasma display panel driving method in which a plasma display panel including a plurality of scan electrodes and a plurality of sustain electrodes for constituting display electrode pairs is driven so that one field period has a plurality of sub-fields, each including a setup period, an address period, and the sustain period, the driving method comprising:
in the sustain period of at least one of the sub-fields in the one field period, generating at least two kinds of sustain pulses: one sustain pulse having a steeper fall than another sustain pulse; and the other sustain pulse having a steeper rise than another sustain pulse; and
immediately after applying the sustain pulse having the steeper fall to one electrode of each of the electrode pairs, applying the sustain pulse having the steeper rise to an other electrode of each of the electrode pairs.

7. The plasma display panel driving method of claim 6, further comprising:
generating and periodically switching at least three kinds of sustain pulses: a first sustain pulse, i.e. a reference pulse; a second sustain pulse having a steeper rise than other sustain pulses; and a third pulse having a steeper fall than other sustain pulses, and
in the sustain period of at least one of the sub-fields in the one field period, immediately after applying the third sustain pulse to the one electrode of each of the display electrode pairs, applying the second sustain pulse to the other electrode of each of the display electrode pairs.
